(19) United States
(12) Patent Application Publication
(10) Pub. No.: US 2011/0032720 A1
(43) Pub. Date: Feb. 10, 2011

(54) High and low beam headlamp with a pivoting multifaceted reflector

(76) Inventors: Xiaolu Chen, Cranberry Twp, PA (US); James M. Helms, Fort Myers, FL (US)

Correspondence Address: KAREN TANG-WAI SODINI, 216 horseshoe drive, MARS, PA, 16046, US

(21) Appl. No.: 12/462,493

(22) Filed: Aug. 4, 2009

(51) Int. Cl. F21V 7/00; B60Q 1/00

(52) U.S. Cl. 362/516; 362/538; 362/547

(57) ABSTRACT

A vehicle headlamp having a pivotal multifaceted reflector, a light source, and an actuator typically including a solenoid, the actuator disposed and coupled to the multifaceted reflector and to other portions of the headlamp so as to pivot, under the action of the actuator, into a first position to generate a first beam of light serving as a high beam, and into a second position to generate a second beam of light serving as a low beam, and so providing a high beam and a low beam using the same light source, fixed within the headlamp, and a single reflector. In some embodiments, the high beam meets FMVSS 108 requirements for a vehicle headlamp high beam, and the low beam meets FMVSS 108 requirements for a vehicle headlamp low beam.

### FIELD OF THE INVENTION

The present invention pertains to the field of lighting or illumination. More particularly, the present invention pertains to the field of vehicle headlamps having variable beam settings.

### BACKGROUND OF THE INVENTION

The Federal Motor Vehicle Safety Standard (FMVSS) 108 for vehicle lighting requires headlamps to generate high beam and low beam patterns defined by an array of points at each of which the beams are required to have a specified intensity or to have an intensity in a specified range of intensities. Currently, typical high beams and low beams provided by a headlamp are achieved using one incandescent light source with a reflector designed to generate a high beam, and another such light source with a reflector designed to generate a low beam. Hence, at a minimum, in such headlamps two different incandescent light sources and two different reflectors are used to generate the two beam patterns.

In terms of radiated power per unit input electrical power, incandescent bulbs that are currently typically used are inefficient light sources, compared to other available light sources such as light-emitting diode (LED), halogen, or high intensity discharge (HID) light sources. Additionally, LED light sources, in particular, allow for a smaller design without impacting performance, and last longer than incandescent bulbs. A major drawback of LED light sources, however, is that the heat generated by the LED, though less, is more concentrated, i.e. occurs in a smaller volume, and this can make removing the heat more challenging.

It would be useful to have a headlamp that uses the same light source and a single reflector to produce both a high beam and a low beam, as reducing the overall number of components within the headlamp is likely to reduce the overall cost of the headlamp.

### SUMMARY OF THE INVENTION

The present invention is a headlamp using a light source, typically an LED light source, to provide both a high beam and a low beam, which is done by pivoting a single multifaceted reflector so as to change the position of the reflector relative to the LED light source. The pivoting is typically performed using a solenoid or equivalent electromechanical device.

### BRIEF DESCRIPTION OF THE DRAWINGS

The features and advantages of the invention will become apparent from a consideration of the subsequent detailed description presented in connection with accompanying drawings, in which:

FIG. 1 is a perspective view of a headlamp according to an embodiment of the invention.

FIG. 2 is a top cross-sectional view of the headlamp interior components.

FIG. 3 is a front view of the interior components of the headlamp of FIG. 1, showing a reflector in a neutral or low beam position.

FIG. 4 is a cross-sectional side view of the headlamp of FIG. 1, showing the reflector in the tilted or high beam position.

FIG. 5 is a cross-sectional side view of the headlamp of FIG. 1, showing the reflector in the neutral or low beam position, and further showing the cover with an LED driver mounted to an interior surface.

FIG. 6 is a perspective view of the headlamp cover and window.

FIG. 7 is a front view of the headlamp of FIG. 1, showing the headlamp's interior components.

FIG. 8 is an exploded view of the reflector, hinges and bar.

FIG. 9 is a perspective view of the assembled reflector, hinges and bar.

### DRAWINGS LIST OF REFERENCE NUMERALS

The following is a list of reference labels used in the drawings to label components of different embodiments of the invention, and the names of the indicated components.
10 high and low beam headlamp with rotating reflector without a headlamp cover
20 headlamp housing
20a headlamp cover or faceplate
20b window or cover lens
20c fins
24 light assembly
24b light source
26 bar
28 actuator
28a plunger
28b fixed or non-moving portion of the actuator
28c first bracket
28d second bracket
30 reflector
30a center area of reflector contributing to entire beam pattern
30b middle area of reflector contributing to middle portion of beam pattern
30c end area of reflector forming hotspot portion of light beam
40 vertex
42 hinge
42a first end of hinge
42b second end of hinge
44 light source power regulator

### DETAILED DESCRIPTIONS

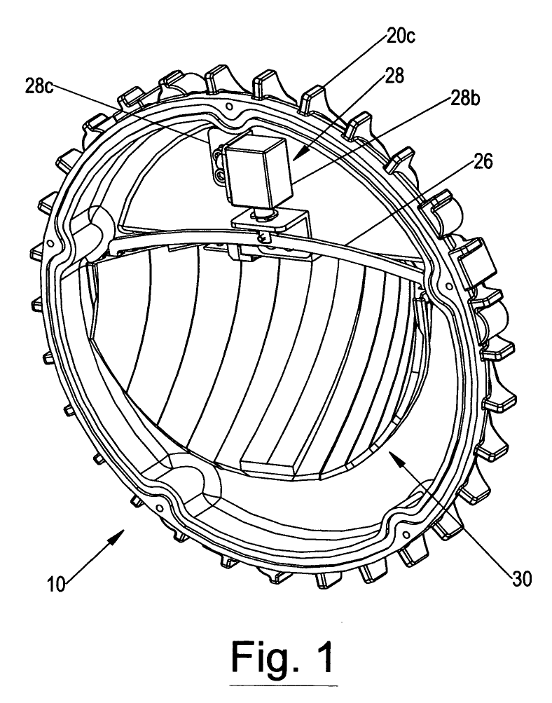

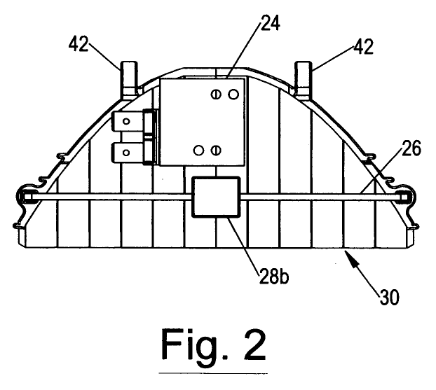

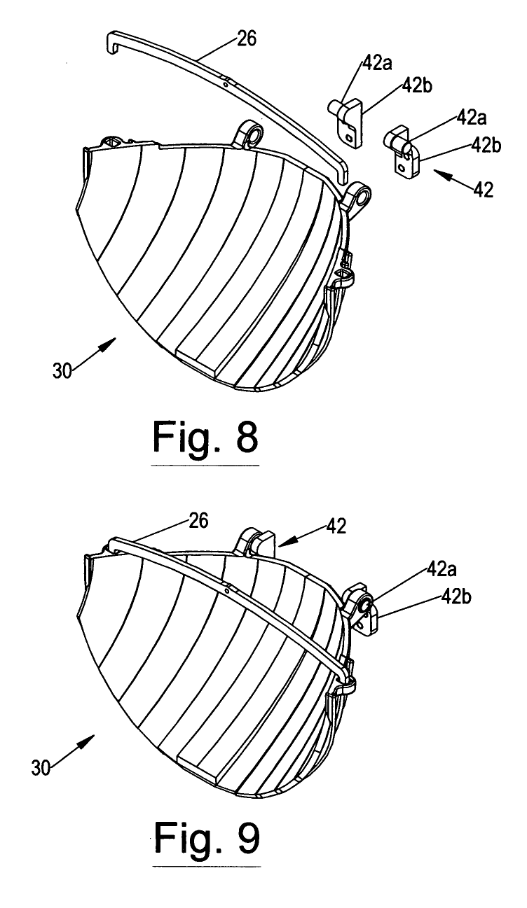

FIGS. 1 to 9 show a headlamp 10 according to an embodiment of the invention, the headlamp 10 generally comprising a housing 20 having at least a partially enclosed inner space, the inner space holding a light source 24b, typically a light emitting diode (comprising one or more LED chips), as a component of a light assembly 24, the assembly further including electrical connections, and a printed circuit board serving as a mounting substrate, the assembly 24 fixedly attached to an interior wall of the housing 20.

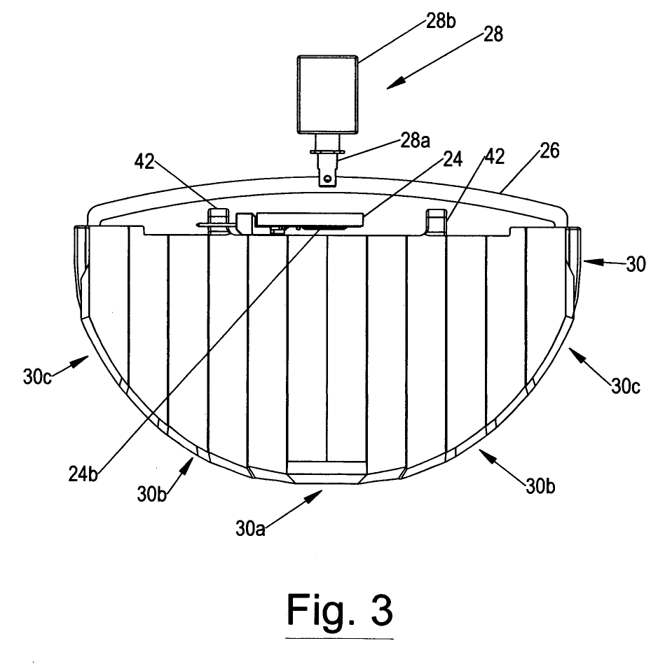

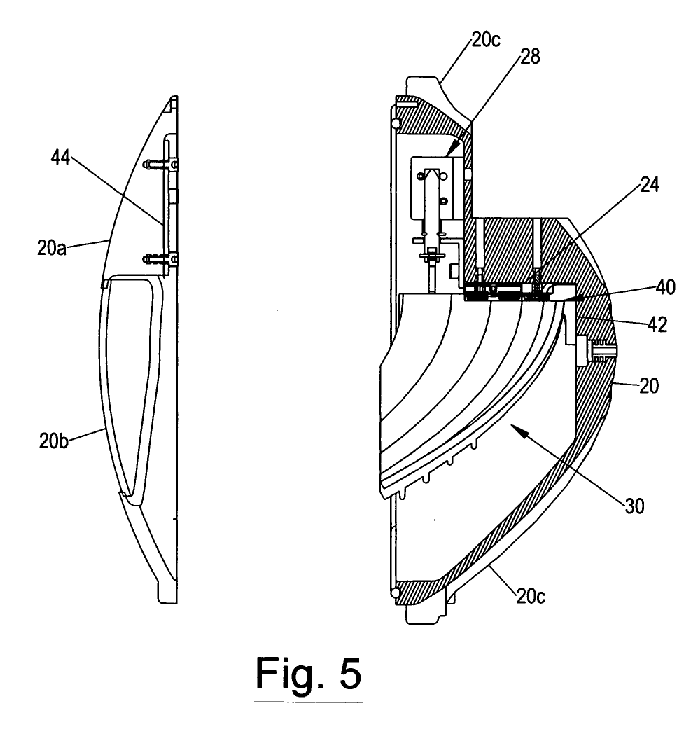

A reflector 30 is pivotally attached to a first end of a hinge 42a at a vertex 40 (FIGS. 5, 8 and 9). A second end 42b of the hinge 42 is fixedly attached to the housing 20 (FIGS. 5, 8 and 9). The reflector 30 further comprises reflective surfaces 30a 30b 30c oriented to face the light source 24b (FIG. 3). The reflector is spanned by, and attached to, a bar 26 across the reflector's widest diameter (FIG. 9).

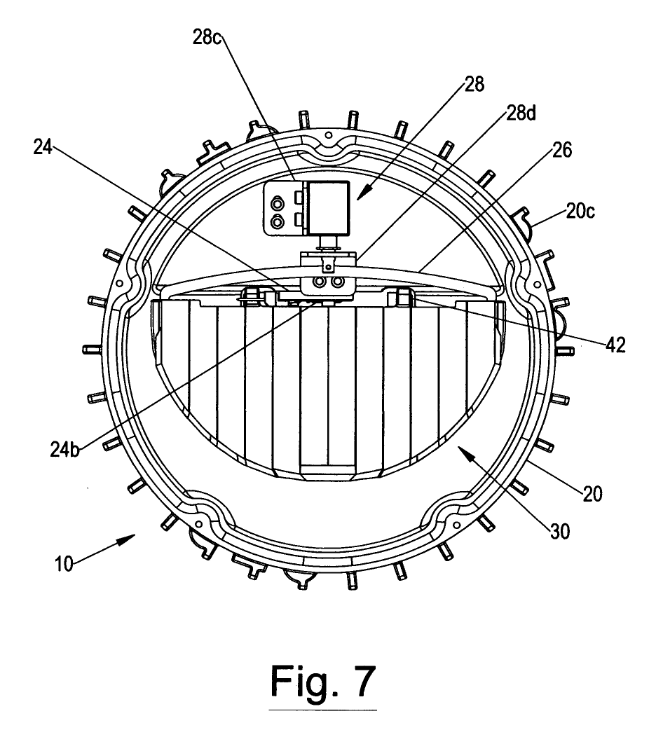

Attached to the bar 26 is an actuator 28 having a fixed or non-moving portion 28b and a movable plunger 28a, the fixed portion 28b rigidly attached by a first bracket 28c to the housing 20, and the plunger 28a attached to the bar 26 (FIG. 3). In some embodiments (not shown), two actuators may be employed, one at each opposite end of the reflector. The vertical path of the moving plunger 28a is additionally guided by a second bracket 28d (FIG. 7), the bracket having a hole through which the plunger 28a is inserted. The bracket 28d is further attached to the housing 20.

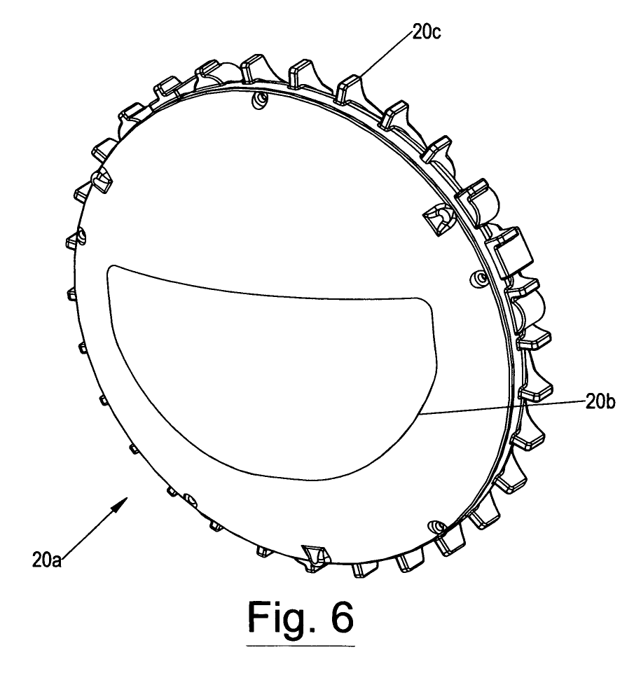

Referring now to FIGS. 5 and 6, a headlamp cover or faceplate 20a is affixed to the housing 20, the faceplate 20a comprising a window or cover lens 20b made of a transparent material, such as glass, and an opaque portion that, along with the housing 20, are both typically made of aluminum. It should be noted that the cover lens 20b merely covers or protects the interior components while allowing the light generated by the headlamp to be transmitted through it, and does not in fact form an image or contribute to the formation of an image or a beam. In the embodiment shown in FIG. 5, on an interior wall of the opaque portion of the faceplate is a light source power regulator 44, such as an LED driver, for providing constant current to the light source 24b. Fins 20c are molded into the housing 20, serving as heatsinks for the interior components, directing the heat generated by the light source 24b out of the headlamp. The opaque aluminum faceplate 20a further serves as a heatsink for the LED driver 44 in the embodiment shown in FIG. 5, or in other embodiments (not shown), for other heat generating electrical components housed on the faceplate's interior wall.

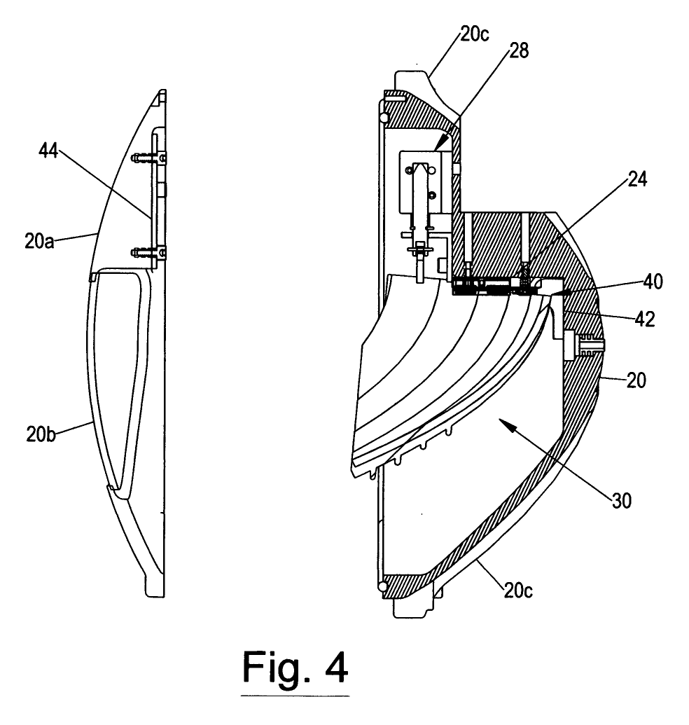

A light source such as an LED light source, a HID bulb, a halogen bulb, or any other light source is positioned at the focal point or vertex 40 of the reflector (FIGS. 4 and 5). The reflector is positioned with its plurality of reflective facets facing the light source 24b, and thus the reflector may be positioned so that the facets face downwards (as shown in the embodiments in FIGS. 4 and 5) or upwards (not shown). In the embodiment of the invention shown in FIGS. 1-9, a light-emitting diode (LED) is the preferred light source, and as shown more particularly in FIGS. 3, 4 and 5, the LED is shown in a downward facing position. The LED light source may be provided as an array of LED chips disposed over a quite small surface area, so as to act, in effect, as a single light source, or the LED light source may instead be provided as one single LED chip as a component of the light assembly 24. It is to be understood that a light source according to the invention may be a single source, for instance a single LED chip, or it may be comprised of a plurality of light producing sources, but it should be understood that the term “light source” used herein means the same light source (regardless of how that light is produced) is used to generate two different beam patterns.

As shown more particularly in FIG. 3 the reflector 30 is typically composed of a plurality of free-formed reflecting facets. In the embodiment shown in FIGS. 1-9, the optimal number of facets is 12, but could also comprise more or fewer facets. Looking at the reflector horizontally, from left to right, the reflecting facets in a central area 30a are shaped to contribute to the overall beam pattern, the facets located at the far left and right areas 30c of the reflector direct light primarily to the central region of the beam, creating a beam hot spot, i.e. a region of small area where the beam has its highest intensities. The facets located in a middle area 30b of the reflector, contribute to the middle of the beam pattern. While the general shape of the reflector might casually be described as concave, it is to be understood that the reflector 30 is comprised of individual facets, each facet being freely formed, i.e. are not constrained to be concave and instead may even be convex, as required to obtain the two desired beams, and thus the shape of the reflector cannot accurately be described as concave.

In the embodiment described in FIGS. 1-9, low beam light is achieved when the reflector 30 is at a default or neutral position (low beam position), as shown more particularly in FIG. 5. Referring more particularly to FIG. 4, for high beam light, the beam pattern is shifted upward by pivoting the multifaceted reflector, accomplished by supplying voltage to the actuator 28, causing the metal plunger 28a to move upwards, pulling up the bar 26, and thus rotating the reflector upwards, preferably about its axis at the vertex 40 of the reflector 30. The axis of rotation is typically perpendicular to the optical axis and passes through the vertex point 40 of the reflector 30.

The high beam and low beams are, for purposes here, defined by respective photometry requirements, each of which may be understood as specifying a beam intensity or range of intensities at each of a plurality of spatially separated co-planar points. A beam pattern for a headlamp has points of intensity at locations specified by reference to a vertical reference line and a horizontal reference line. These two lines intersect on an optical axis of the headlamp after the optical axis is adjusted to be parallel to the longitudinal axis of the vehicle on which the headlamp is mounted the location is specified in degrees to the right or left of the vertical reference line, and above or below the horizontal reference line. When the beam is projected onto a screen 30 m away, one degree (0.017 radians) corresponds to a distance length of 0.52 m.

For low beam, FMVSS 108 specifies as the point of maximum intensity of the beam pattern a point that is 2.0 degrees to the right of the vertical reference line, and 1.5 degrees below the horizontal reference line. For high beam, FMVSS 108 specifies the intersection of the vertical and horizontal reference lines as the point of maximum intensity of the beam pattern. It is important to note that FMVSS 108 does not require the two beam patterns to have respective maximum intensities at these two locations, here called the specified hot points; it requires only that the two beam patterns have at least some specified respective intensities at those specified hot points. Thus it is possible to satisfy FMVSS 108 by providing beams that have the required intensities at the specified hot points, but actually have higher intensities elsewhere (usually close by).

In order to satisfy the low beam and high beam photometry requirements using one light source and one pivotable reflector 30, the reflector is designed so what when it is in its low beam position, the hot spot is closer to the center vertical line of beam symmetry than is typically found for a low beam hot spot. The actual maximum intensity of the low beam pattern is at a point that is approximately 1.5 degrees below the horizontal reference line, and at range of from approximately directly on the vertical reference line to 0.5 degrees to the right of the vertical reference line, and additionally still provides the required intensity at the specified hot spot for the low beam. In the embodiment described herein, it is preferable to aim the low beam hot spot just to the right of the vertical reference line. In the case where the low beam light is an independent beam, the maximum intensity should be aimed at about 1.5 degrees below the horizontal reference line, and about 2 degrees to the right of the vertical reference line. When the actuator is energized so that the reflector is pivoted upwards, switching from the low beam to the high beam, the hot spot is shifted upward to cover the so-called “HV point”—the point at which the horizontal line of beam symmetry and the vertical line of beam symmetry cross each other. The actual maximum intensity for the high beam resides on the horizontal reference line (or substantially so) and typically only 0.5 to 1.0 degrees to the right of the vertical reference line, and thus only about one third to two thirds of the way from the vertical reference line to the specified hot spot. This design approach facilitates satisfying high beam photometry requirements. The angle of rotation of the reflector is typically only a couple of degrees.

The invention is here described using the actuator 28 (FIG. 3) attached to the bar 26 to pivot the reflector upward. The actuator may be a solenoid or other electromechanical device, such as a micro-motor, or, in general, may be any electromechanical device able to pull up or down on a reflector, and thus pivot the reflector on a hinge.

It is to be understood that the above-described arrangements are illustrative of one embodiment of the invention only, and does not preclude other embodiments of the invention using a light source distributed over a not quite small area. The same principles for designing the multifaceted reflector disclosed herein also apply to other such embodiments.

It is to be understood that the above-described arrangements are only illustrative of the application of the principles of the present invention. Numerous modifications and alternative arrangements may be devised by those skilled in the art without departing from the scope of the present invention, and the appended claims are intended to cover such modifications and arrangements.

What is claimed is:

1. A headlamp, comprising:
a housing (20) at least partially enclosing an interior space;
a light source (24b) disposed within the interior space and attached to the housing;
a hinge (42) having two sections pivotally connected by a bearing along a pivoting axis (40), and disposed within the interior space with one section attached to the housing (20);
a multifaceted reflector (30) disposed within the interior space and attached to the other section of the hinge (42), whereby the multifaceted reflector is pivotally connected to the housing (20); and
an actuator (28) coupled to the multifaceted reflector (30) and to the housing (20), and configured so as to respond to an applied voltage by pushing or pulling on the multifaceted reflector and so causing the multifaceted reflector to pivot about the pivoting axis (40) of the hinge (42) and thereby change the orientation of the multifaceted reflector (30) relative to the housing (20).

2. A headlamp as in claim 1, wherein the actuator (28) comprises a solenoid or other electromechanical device.

3. A headlamp as in claim 1, wherein the multifaceted reflector is formed to provide a first beam pattern in accordance with a motor vehicle specification when oriented in a first orientation relative to the housing and a second beam pattern in accordance with the motor vehicle specification when oriented in a second orientation relative to the housing, wherein the two beam patterns are each defined by light intensities at a finite set of points in a planar surface.

4. The headlamp as in claim 1, further comprising a heatsink (20a 20c) attached to the light source (24b) and to the housing (20), whereby heat generated by the interior components is directed away from those components and out the headlamp housing.

5. A headlamp as in claim 1, further comprising a bar (26) attached to and spanning the diameter of the reflector, wherein the actuator (28) is coupled to the bar and thus also to the multifaceted reflector, and wherein supplying voltage to the actuator causes a plunger portion (28a) of the actuator to lift upwards, pulling the bar and the attached reflector into a first position to create high beam light.

6. A headlamp as in claim 5, wherein a stopping voltage to the actuator (28) causes the plunger portion (28a) of the actuator to drop downwards, dropping the reflector into a second position to create low beam light.

7. A headlamp as in claim 1, wherein the multifaceted reflector is provided so as to provide a specified low beam pattern when in one position and so as to provide a specified high beam pattern when in a second position arrived at by a pivoting action starting from the first position, wherein the specified low beam pattern includes a specified hot spot where a point of maximum specified intensity is located with reference to a vertical reference line and a horizontal reference line, and wherein when the multifaceted reflector is disposed in position to provide a low beam, a point of maximum intensity is provided at a location approximately one third to two thirds of the way from the vertical reference and the specified hot spot for the low beam.

8. The headlamp of claim 1, wherein the housing (20) and faceplate (20a) are both made of aluminum.
